(19) United States
(12) Patent Application Publication
(10) Pub. No.: US 2007/0229725 A1
(43) Pub. Date: Oct. 4, 2007

(54) Liquid Crystal Display Device

(76) Inventor: Jeoung-gwen Lee, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/671,260

(22) Filed: Feb. 5, 2007

(30) Foreign Application Priority Data
Feb. 3, 2006 (KR) 10-2006-0010812

(51) Int. Cl. G02F 1/1333

(52) U.S. Cl. 349/58

(57) ABSTRACT

A liquid crystal display device comprises a liquid crystal display panel, a light guiding plate provided behind the liquid crystal display panel, a light source, which is provided on at least one lateral side of the light guiding plate, comprising a tamp body to emit light and lamp holders located at opposite ends of the lamp body, a holder cover which covers the lamp holders, and a lamp body cover separated from the holder cover and provided around the tamp body for reflecting light from the lamp body into the light guiding plate.

### CROSS-REFERENCE TO RELATED APPLICATIONS

This application claims the benefit of Korean Patent Application No. 2006-0010812, filed on Feb. 3, 2006, in the Korean Intellectual Property Office, the disclosure of which is incorporated herein by reference in its entirety.

### BACKGROUND OF THE INVENTION

1. Field of the Invention

The present invention relates to a liquid crystal display (LCD) device.

2. Description of Related Art

Flat display devices such as a liquid crystal displays (LCDs), a plasma display panels (PDPs) and organic light emitting diodes (OLEDs) have been developed to replace cathode ray tubes (CRTs).

An LCD device comprises a liquid crystal display panel including a thin film transistor substrate, a color filter substrate, and a liquid crystal layer interposed between the thin film transistor substrate and the color fitter substrate. As the LCD device does not emit light by itself, it has a backlight unit behind the thin film transistor substrate to supply light. The amount of transmittance of light emitted from the backlight unit is adjusted according to an alignment of liquid crystals in the liquid crystal layer.

The backlight unit may be classified into an edge type and a direct type according to a position of a light source. The edge type backlight unit has a structure where the light source is disposed at a lateral side of a light guiding plate, and is typically employed in a small LCD device such as a laptop computer or a desktop computer. The edge type backlight unit has good light uniformity, durability and occupies a small space in the LCD device.

The edge type backlight unit employs a light source cover to reflect light from the light source to the light guiding plate. However, the light source cover may cause some light to leak out, thereby lowering efficiency of the light source.

### SUMMARY OF THE INVENTION

According to an embodiment of the present invention, a liquid crystal display device comprises a liquid crystal display panel, a light guiding plate which is provided behind the liquid crystal display panel, a light source, which is provided on at least one lateral side of the tight guiding plate, comprising a lamp body emitting light and lamp holders located at opposite ends of the lamp body, a holder cover which covers the lamp holders, and a lamp body cover separated from the holder cover and provided partially around the lamp body to reflect light from the lamp body into the light guiding plate.

According to the embodiment of the invention, the holder cover comprises a holder cover main body which covers the lamp holders, and a reinforcing part which extends from the holder cover main body.

According to the embodiment of the invention a section of the holder cover main body in a lengthwise direction of the lamp body corresponds to the outer surface of the tamp holder.

According to the embodiment of the invention, the holder cover main body is opened in the lengthwise direction of the light source.

According to the embodiment of the invention, the holder cover main body further comprises a lateral reinforcing part which faces an end part of the lamp holder, the lateral reinforcing part including a through hole formed therein.

According to the embodiment of the invention, a section of the light guiding plate provided substantially parallel with the liquid crystal display panel has a substantially rectangular shape.

According to the embodiment of the invention, the holder cover comprises metal, and the lamp body cover comprises plastic.

According to the embodiment of the invention the holder cover comprises one of aluminum and a zinc-galvanized steel plate.

According to the embodiment of the invention, the liquid crystal display device further comprises a reflection plate which includes a first part located behind the light guiding plate, wherein the lamp body cover comprises a second part extending from the first part toward the liquid crystal display panel and faces the light guiding plate, with the tamp body interposed between the lamp body cover and the light guiding plate.

According to the embodiment of the invention, the tamp body cover further comprises a third part extending from the second part over the lamp body.

According to the embodiment of the invention, the liquid crystal display device further comprises a mold provided between the light guiding plate and the liquid crystal display panel, and in which the liquid crystal display panel is seated, wherein the lamp body cover further comprises a reflection layer which is formed on the mold of the lamp body.

According to the embodiment of the invention the liquid crystal display device further comprising a cover member which accommodates the light guiding plate and the light source, wherein the reinforcing part is attached to the cover member.

According to the embodiment of the invention, the cover member is formed with a rear cover through hole and the reinforcing part is formed with a holder cover through hole, further comprising a screw coupled with the rear cover through hole and the holder cover through hole to couple the reinforcing part with the cover member.

According to an embodiment of the present invention, a backlight unit comprises a light guiding plate; a light source which is provided on at least one lateral side of the light guiding plate, comprising a lamp body emitting light and lamp holders located at opposite ends of the lamp body; a holder cover which covers the tamp holders; and a lamp body cover separated from the holder cover and provided partially around the lamp body to reflect tight from the tamp body into the light guiding plate.

According to the embodiment of the invention, the backlight unit further comprising a cover member which accommodates the light guiding plate and the tight source, wherein the reinforcing part is attached to the cover member.

According to the embodiment of the invention the cover member is formed with a rear cover through hole and the reinforcing part is formed with a holder cover through hole, further comprising a screw coupled with the rear cover through hole and the holder cover through hole to couple the reinforcing part with the cover member.

### BRIEF DESCRIPTION OF THE DRAWINGS

The present invention will become apparent and more readily appreciated from the following description of exemplary embodiments, taken in conjunction with the accompanying drawings of which:

FIG. 1 is an exploded perspective view of a liquid crystal display device according to an embodiment of the present invention;

FIG. 2 is a sectional view taken along line II-II in FIG. 1;

FIG. 3 is a sectional view taken along line III-III in FIG. 1;

FIG. 4 is a perspective view of a reflection plate of a liquid crystal display device according to an embodiment of the present invention;

FIG. 5 is a sectional view of the liquid crystal display device of FIG. 4;

FIG. 6 is a perspective view of a holder cover of liquid crystal display devices according to an embodiment of the present invention; and

FIG. 7 is a perspective view of a holder cover of liquid crystal display devices according to an embodiment of the present invention, respectively.

### DETAILED DESCRIPTION OF PREFERRED EMBODIMENTS

Hereinafter, exemplary embodiments of the present invention will be described with reference to accompanying drawings, wherein like numerals refer to like elements and repetitive descriptions will be avoided as necessary.

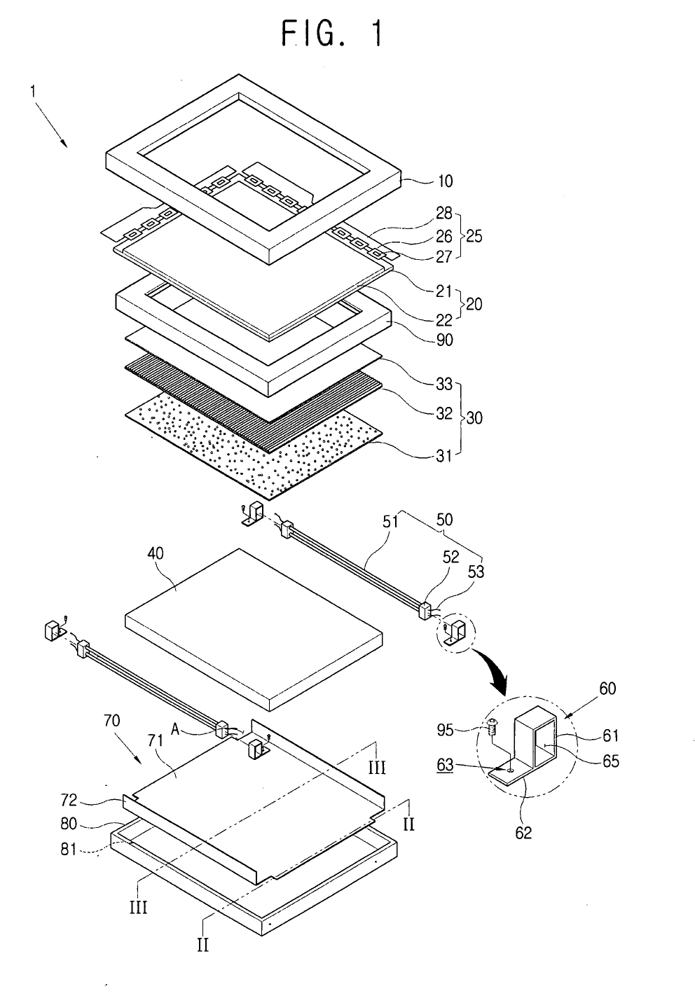

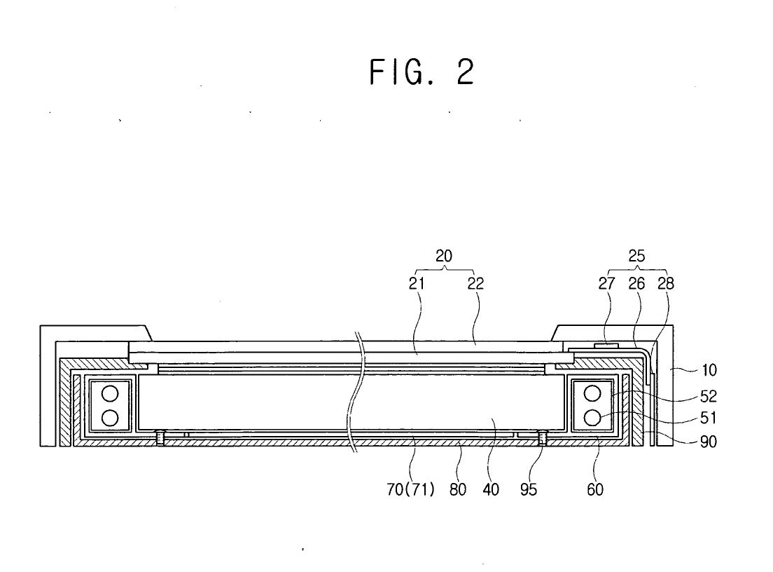

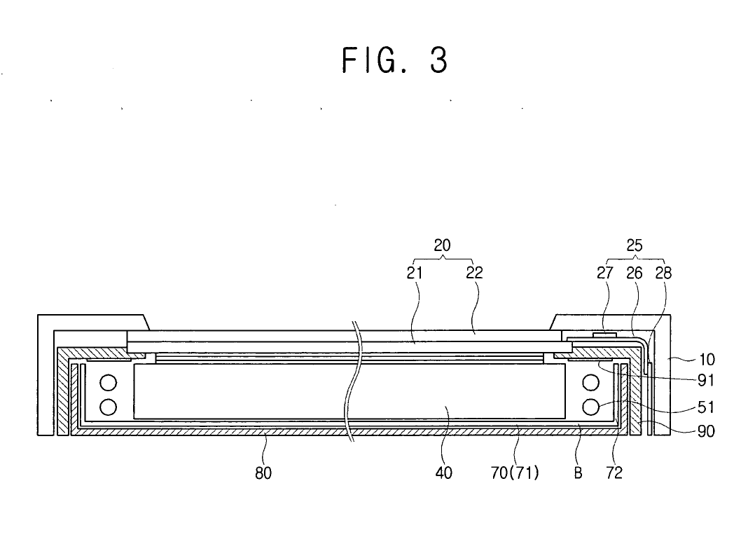

Hereinafter, a liquid crystal display (LCD) device according to an embodiment of the present invention will be described with reference to FIGS. 1 to 3.

Referring to FIGS. 1 to 3, an LCD device 1 comprises an LCD panel 20, a plurality of optical films 30 which is provided behind the liquid crystal display panel 20, a light guiding plate 40 which is provided behind the liquid crystal display panel 20, a pair of light sources 50 which is provided at lateral sides of the light guiding plate 40, a holder cover 60 which covers a lamp holder 52 of the light sources 50, and a reflection plate 70 which is provided below the light guiding plate 40. The foregoing elements are accommodated between a front cover 10 and a rear cover 80. The LCD panel 20 is stably seated on a plastic mold 90.

The LCD panel 20 comprises a thin film transistor substrate 21 on which thin film transistors are formed, and a color filter substrate 22 which faces the thin film transistor substrate 21. A liquid crystal layer (not shown) is provided between the thin film transistor substrate 21 and the color filter substrate 22. The LCD panel 20 displays an image by adjusting an alignment of liquid crystals in the liquid crystal layer. The LCD panel 20 receives light from the light sources 50. A driver 25 is provided at a lateral side of the thin film transistor substrate 21 to supply a driving signal. The driver 25 comprises a flexible printed circuit board (FPC) 26, a driving chip 27 mounted on the FPC 26, and a printed circuit board (PCB) 28 connected with a lateral side of the FPC 26. The driver 25 may be implemented as a chip on film (COF) type driver, but not limited thereto. For example, the driver 25 may be implemented as a tape carrier package (TCP), a chap on glass (COG) driver, etc. The driver 25 may be mounted on the thin film transistor substrate 21.

The optical films 30, which are provided behind the LCD panel 20, comprise a diffusion film 31a prism film 32 and a passivation film 33.

The diffusion film 31 comprises a base plate and a bead-like coating layer, which is formed on the base plate. The diffusion film 31 diffuses light from the light sources 50 to be supplied to the LCD panel 20. The diffusion film 31 may be provided in two or three folds.

On the prism film 32 are formed triangular prisms at regular intervals. The prism film 32 collects light diffused by the diffusion film 31 in a direction substantially perpendicular to the LCD panel 20. The prism film 32 is typically provided in two sheets. Micro prisms which are formed on each of the prism films 32 form a predetermined angle. Light passing through the prism film 32 travels in a substantially vertical direction to provide uniform brightness.

The passivation film 33 on the prism film protects the prism film 32 from being scratched.

The light guiding plate 40 is formed of an acrylic resin such as polymethylacrylate. The light guiding plate 40 uniformly provides light from the light sources 50 to the diffusion film 31. According to an exemplary embodiment, the light guiding plate 40 has a rectangular shape whose corner or side is not partly removed.

The light sources 50 are provided as a pair and face each other, with the light guiding plate 40 interposed therebetween. According to an exemplary embodiment, each of the light sources 50 comprises a lamp body 51, lamp holders 52 provided at opposite ends of the lamp body 51, and a power supply cable 53 which extends from the lamp holders 52.

The power supply cable 53, through which power is supplied to the lamp body 51 is connected with an inverter (not shown) provided behind the rear cover 80. The lamp holders 52 are disposed at opposite ends of the lamp body 51, have an approximately hexahedral shape, and cover an electrode part (not shown). The lamp holders 52 are made of plastic. The light sources 50 may comprise a cold cathode fluorescent lamp (CCFL) or an exterior electrode fluorescent lamp (EEFL).

Respective holder covers 60 cover each of the lamp holders 52. The holder covers 60 may be made of metal such as aluminum or a zinc-galvanized steel plate. The holder covers 60 may be manufactured by a mold.

Each holder cover 60 comprises a holder cover main body 61 having a holder accommodating space 65 for receiving the lamp holder 52 and a reinforcing part 62 which extends from the holder cover main body 61. The holder cover main body 61 has an box or [symbol] -shaped section in a direction transverse to an extension direction of the light sources 50 to correspond to the outer surface of the lamp holder 52. The holder cover main body 61 is open in the extension direction of the light source 50. The lamp holder 52 are inserted into the opening (i.e., the holder accommodating space 65) of the holder cover main body 61 through which the power supply cable 53 is drawn. The holder accommodating part 65 is provided to allow the lamp holders 52 to be inserted thereinto and to restrict the accommodated lamp holders 52 from moving. It is preferable but not necessary that the holder accommodating part 65 is slightly larger than the lamp holders 52.

A portion of the holder cover main body 61 is located between the lamp holders 52 and the light guiding plate 40, to prevent the lamp holders 52 and the light guiding plate 40 from directly contacting each other.

A holder cover through hole 63 is formed on the reinforcing part 62. A rear cover through hole 81 is formed on the rear cover 80 to correspond to the holder cover through hole 63. A screw 95 is coupled with the holder through hole 63 and the rear cover through hole 81 to fix the holder cover 60 on the rear cover 80.

The reflection plate 70 is located behind the light guiding plate 40 and reflects light back to the light guiding plate 40. The reflection plate 70 is made of plastic such as polyethylene terephthalate (PET) or polycarbonate (PC).

According to an exemplary embodiment four corners A of the reflection plate 70 are removed. The holder covers 60 are located in portions corresponding to the removed corners A. Accordingly, the holder covers 60 directly contact the rear cover member 80.

The reflection plate 70 comprises a first part 71 which is provided behind the light guiding plate 40, and a pair of second parts 72 which are bent and extend upward from the first part 71. The second parts 72 are bent in a direction substantially perpendicular to the first part 71 and disposed at lateral sides of the tamp body 51. The length of the second parts 72 corresponds to that of the lamp body 51. The lamp body 51 is located between the tight guiding plate 40 and the second parts 72.

The mold 90 is located on the tamp body 51. A reflection layer 91 is formed below the mold 90 facing the lamp body 51. The reflection layer 91 may be formed by attaching a plastic film such as PET.

According to an exemplary embodiment, a portion B, which is below the tamp body 51, and the second parts 72 of the reflection plate 70, and the reflection layer 91 are provided around the tamp body 51 and form a tamp body cover which reflects light from the lamp body 51 to the light guiding plate 40.

According to an exemplary embodiment, the holder covers 60 made of metal are not formed around the lamp body 51. Instead, the reflection plate 70, the reflection layer 91 and so on are formed around the lamp body 51. Accordingly, leakage of light from the lamp body 51 can be reduced, thereby improving efficiency of the light sources 50. The improved efficiency of the light sources 50 decreases power consumption, thereby towering the amount of heat generated in the light sources 50.

When a holder cover extends to form a tamp body cover, a power supply cable may be damaged by burrs generated in a molding process. Accordingly to an exemplary embodiment, the holder covers 60 cover the tamp holders 52 alone, thereby substantially preventing the power supply cable 53 from being damaged due to burrs.

Hereinafter, the tight guiding plate 40 having a substantially rectangular section in parallel with the liquid crystal display panel 20 wilt be described in more detail.

Since tight guiding plates are typically thick and heavy, they may damage the lamp holders if shaken to contact the lamp holders 52. According to an exemplary embodiment of the present invention, the corners of the light guiding plate 40 are trimmed off to substantially prevent contact with the lamp holders 52. In addition, to suppress the light guiding plate 40 from shaking, lateral sides of the light guiding plate 40 are formed having an uneven surface and coupling parts provided in the rear cover 80 correspond to the uneven surface of the light guiding plate 40.

According to an exemplary embodiment, the holder covers 60 cover the lamp holders 52 to substantially prevent the light guiding plate 40 from contacting the lamp holders 52. The holder covers 60 are made of metal. The holder covers 60 are attached to the rear cover 80 through a screw 95, thereby effectively preventing the lamp holders 52 from being damaged by the movement of the light guiding plate 40.

With the holder covers 60, the light guiding plate 40 does not damage the lamp holders 52 even if the light guiding plate 40 has a rectangular shape. That is, the corners of the light guiding plate 40 need not be omitted to prevent the light guiding plate 40 from contacting the lamp holders 52. In this manner, when the light guiding plate 40 is formed to have the rectangular shape, the processes of removing the corners and forming the uneven surface of the light guiding plate 40 and the rear cover 80 may be omitted, thereby improving productivity.

The corners A of the reflection plate 70 may not be removed. In this case through holes are formed in the reflection plate 70 through which the screws 95 pass. The holder covers 60 may be formed with the holder cover main body 61 alone without the reinforcing part 62.

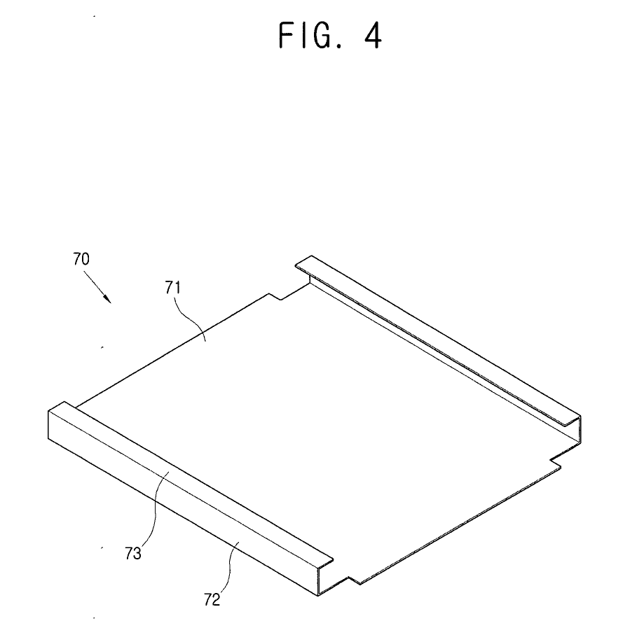

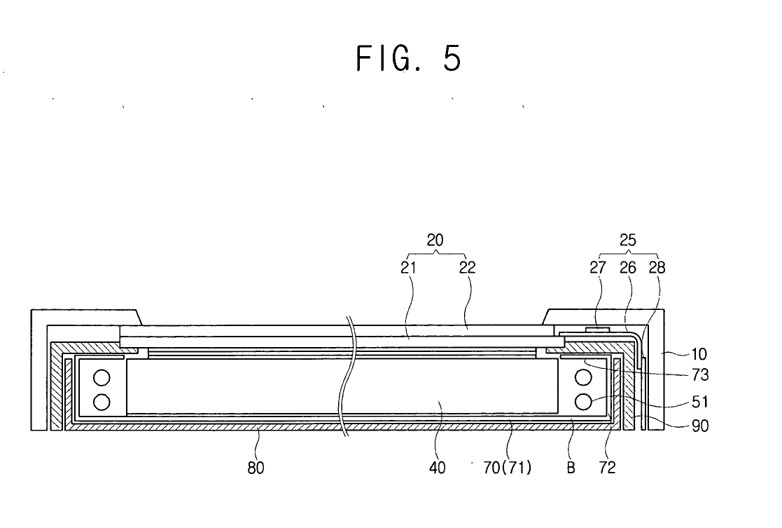

Referring to FIGS. 4 and 5, a liquid crystal display device according to an exemplary embodiment of the present invention will be described.

Referring to FIGS. 4 and 5, a reflection plate 70 according to an exemplary embodiment of the present invention further comprises a third part 73 which is bent and extends from a second part 72. The third part 73 extends from the second part 72 and is substantially parallel to a first part 71. The third part 73 provided on a lamp body 51.

A portion B, the second part 72 and the third part 73 of the reflection plate 70 form a lamp body cover to cover the lamp body 51 and reflect light from the lamp body 51 to a light guiding plate 40.

According to an exemplary embodiment, the lamp body cover may be formed by the reflection plate 70 without needing a reflection layer 91.

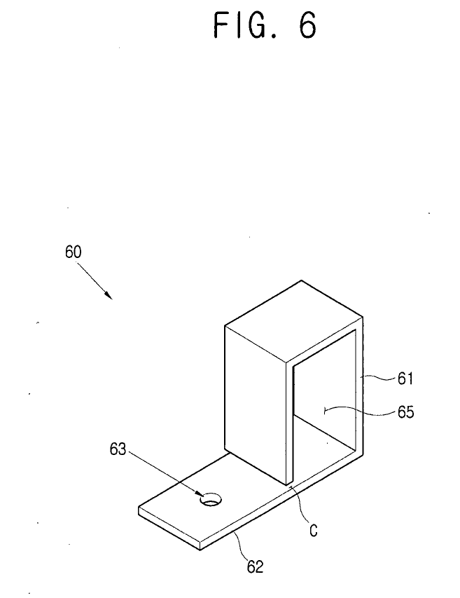

FIG. 6 illustrates a holder cover of a liquid crystal display device according to an exemplary embodiment of the present invention.

A holder cover 60 according to an exemplary embodiment of the present invention is formed by bending a metal layer. A section of a holder cover main body 61 does not form a closed loop and has an opening part C.

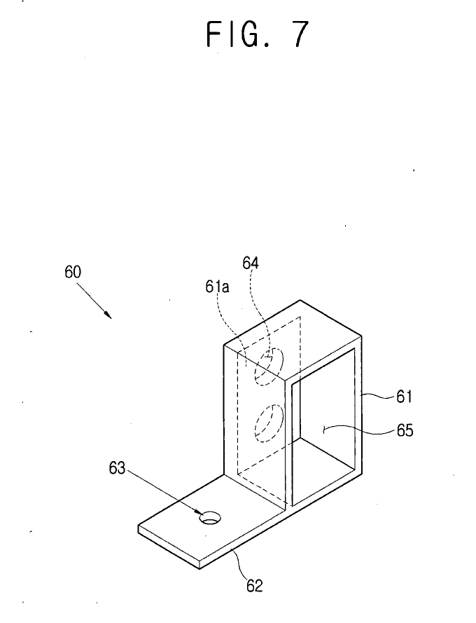

FIG. 7 illustrates a holder cover 60 of a liquid crystal display device according to an exemplary embodiment of the present invention.

A holder cover main body 61 of a holder cover 60 according to an exemplary embodiment of the present invention further comprises a lateral reinforcing part 61a substantially perpendicular to an extension direction of a light source 50. The lateral reinforcing part 61a faces an end of a lamp holder 52 and is formed with a through hole 64 through which a power supply cable 53 may be passed.

The lateral reinforcing part 61a strengthens the holder cover 60 to thereby more effectively prevent a light guiding plate 40 from contacting the lamp holder 52. Also, the lateral reinforcing part 61a substantially prevents the light source 50 from moving in the extension direction of the light source 50.

The lamp holder 52 has been illustrated to have a hexahedral shape, but is not limited thereto. The shape of the tamp holder 52 may by varied depending on that of the lamp holder 52.

As apparent from the above description, the present invention provides a liquid crystal display device with improved efficiency of a light source.

Although exemplary embodiments of the present invention have been shown and described, it wilt be appreciated by those skilled in the art that changes may be made thereto without departing from the principles and spirit of the invention.

What is claimed is:

1. A liquid crystal display device comprising:
a liquid crystal display panel;
a light guiding plate which is provided behind the liquid crystal display panel;
a light source which is provided on at least one lateral side of the tight guiding plate, comprising a lamp body emitting light and lamp holders located at opposite ends of the lamp body;
a holder cover which covers the lamp holders; and
a tamp body cover separated from the holder cover and provided partially around the lamp body to reflect light from the tamp body into the light guiding plate.

2. The liquid crystal display device according to claim 1, wherein the holder cover comprises:
a holder cover main body which covers the lamp holders; and
a reinforcing part which extends from the holder cover main body.

3. The liquid crystal display device according to claim 2, wherein a section of the holder cover main body in a lengthwise direction of the tamp body corresponds to the outer surface of the lamp holder.

4. The liquid crystal display device according to claim 3, wherein the holder cover main body is opened in the lengthwise direction of the light source.

5. The liquid crystal display device according to claim 3, wherein the holder cover main body further comprises:
a lateral reinforcing part which faces an end part of the lamp holder, the lateral reinforcing part including a through hose formed therein.

6. The liquid crystal display device according to claim 1, wherein a section of the light guiding plate provided substantially parallel with the liquid crystal display panel has a substantially rectangular shape.

7. The liquid crystal display device according to claim 1, wherein the holder cover comprises metal, and the lamp body cover comprises plastic.

8. The liquid crystal display device according to claim 1, wherein the holder cover comprises one of aluminum and a zinc-galvanized steel plate.

9. The liquid crystal display device according to claim 1 further comprising:
a reflection plate which includes a first part located behind the light guiding plate, wherein
the lamp body cover comprises a second part extending from the first part toward the liquid crystal display panel and faces the light guiding plate, with the tamp body interposed between the lamp body cover and the light guiding plate.

10. The liquid crystal display device according to claim 9, wherein the tamp body cover further comprises a third part extending from the second part over the lamp body.

11. The liquid crystal display device according to claim 9 further comprising:
a mold provided between the light guiding plate and the liquid crystal display panel, and in which the liquid crystal display panel is seated, wherein
the tamp body cover further comprises a reflection layer which is formed on the mold of the lamp body.

12. The liquid crystal display device according to claim 2, further comprising a cover member which accommodates the light guiding plate and the light source, wherein the reinforcing part is attached to the cover member.

13. The liquid crystal display device according to claim 12 wherein the cover member is formed with a rear cover through hole and the reinforcing part is formed with a holder cover through hole, further comprising:
a screw coupled with the rear cover through hole and the holder cover through hole to couple the reinforcing part with the cover member.

14. A backlight unit comprising,
a light guiding plate;
a tight source, which is provided on at least one lateral side of the light guiding plate, comprising a tamp body emitting light and lamp holders located at opposite ends of the lamp body;
a holder cover which covers the lamp holders, and
a lamp body cover separated from the holder cover and provided partially around the lamp body to reflect light from the lamp body into the light guiding plate.

15. The backlight unit according to claim 14, further comprising a cover member which accommodates the light guiding plate and the light source, wherein the reinforcing part is attached to the cover member.

16. The backlight unit according to claim 15, wherein the cover member is formed with a rear cover through hole and the reinforcing part is formed with a holder cover through hole, further comprising:
a screw coupled with the rear cover through hole and the holder cover through hole to couple the reinforcing part with the cover member.
